(19) United States
(12) Patent Application Publication
(10) Pub. No.: US 2024/0424874 A1
(43) Pub. Date: Dec. 26, 2024

(54) DOOR MODULE PLATE FOR VEHICLE

(71) Applicants: HYUNDAI MOTOR COMPANY, Seoul (KR); Kia Corporation, Seoul (KR); LOTTE CHEMICAL CORPORATION, Seoul (KR)

(72) Inventors: Han Ki LEE, Seoul (KR); Ji Hye PARK, Hwaseong-si (KR); Mun Gyu BAK, Hwaseong-si (KR); Ji Won LEE, Uiwang-si (KR); Byeong Kyu MOON, Gunpo-si (KR); Rae Sung PARK, Bucheon-si (KR)

(73) Assignees: HYUNDAI MOTOR COMPANY, Seoul (KR); Kia Corporation, Seoul (KR); LOTTE CHEMICAL CORPORATION, Seoul (KR)

(21) Appl. No.: 18/519,374

(22) Filed: Nov. 27, 2023

(30) Foreign Application Priority Data
Jun. 21, 2023 (KR) 10-2023-0079885

(51) Int. Cl. B60J 5/04

(52) U.S. Cl. CPC B60J 5/0416; B60J 5/0455

(57) ABSTRACT

A door module plate includes a plate body provided to correspond to a door of a vehicle, a mount portion provided at an edge portion of the plate body and configured to be fastened to a fastening member, an edge groove provided at the edge portion of the plate body, and a reinforcement rib integrally protruding from an internal surface of the edge groove, obtaining an advantageous effect of ensuring rigidity and improving safety and reliability.

### CROSS-REFERENCE TO RELATED APPLICATION

The present application claims priority to Korean Patent Application No. 10-2023-0079885 filed on Jun. 21, 2023, the entire contents of which is incorporated herein for all purposes by this reference.

### BACKGROUND OF THE PRESENT DISCLOSURE

### Field of the Present Disclosure

The present disclosure relates to a door module plate for a vehicle, and more particularly, to a door module plate for a vehicle, which is capable of ensuring structural rigidity and improving safety and reliability.

### Description of Related Art

As the importance of environmental issues has been emphasized in recent years, the use of environmentally friendly materials has been required in various ways. In the vehicle field, the use of recycled materials, such as recycled plastics, is increasing.

However, because recycled plastics are processed by applying heat thereto, it is difficult to ensure sufficient physical properties (e.g., mechanical strength). For the present reason, it is difficult to actively utilize recycled plastics for vehicle components that need to have mechanical strength at a predetermined level or higher to ensure the safety of passengers.

A general door module plate for a vehicle is manufactured by use of a material made by mixing polymer resin and a short-glass-fiber-reinforced composite polypropylene (PP-SGF) material reinforced with fiberglass to improve mechanical strength. In case that a main material of the door module plate is changed to recycled plastic, it is difficult to ensure sufficient mechanical strength of the door module plate.

Therefore, recently, various studies have been conducted to manufacture a door module plate by use of environmental-friendly recycled materials while ensuring mechanical strength, but the study results are still insufficient. Accordingly, there is a need to develop a technology to manufacture a door module plate by use of environmental-friendly recycled materials while ensuring mechanical strength.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a door module plate for a vehicle, which is capable of ensuring structural rigidity of the door module plate and improving safety and reliability of the door module plate.

The present disclosure has been made in an effort to improve mechanical strength of an edge portion of the door module plate on which a sealing member is accommodated.

The present disclosure has also been made in an effort to improve sealing performance.

The present disclosure has also been made in an effort to reduce costs and improve marketability.

The objects to be achieved by the exemplary embodiments are not limited to the above-mentioned objects, but also include objects or effects which may be understood from the solutions or embodiments described below.

An exemplary embodiment of the present disclosure provides a door module plate for a vehicle, the door module plate including: a plate body provided to correspond to a door of a vehicle; a mount portion provided at an edge portion of the plate body and configured to be fastened to a fastening member; an edge groove provided at the edge portion of the plate body; and a reinforcement rib integrally protruding from an internal surface of the edge groove.

According to the exemplary embodiment of the present disclosure, the mount portion may be provided as a plurality of mount portions spaced from one another along the edge portion of the plate body, and the edge groove may be provided between the adjacent mount portions.

According to the exemplary embodiment of the present disclosure, the reinforcement rib may satisfy Expressions 1 and 2 below.

0.26D<H<0.85D [Expression 1]

H∝L [Expression 2]

(Here, H represents a height of the reinforcement rib, D represents a depth of the edge groove, and L represents a spacing distance between the adjacent mount portions.)

According to the exemplary embodiment of the present disclosure, the depth of the edge groove may be defined as 2 mm or less than 2 mm, and a width of the edge groove may be defined as 6 mm or less than 6 mm.

According to the exemplary embodiment of the present disclosure, the height of the reinforcement rib may be defined as 0.5 to 1.5 mm.

According to the exemplary embodiment of the present disclosure, the spacing distance may be defined as 100 to 250 mm.

According to the exemplary embodiment of the present disclosure, the height of the reinforcement rib may be defined to gradually increase in a direction from one end portion of a spacing distance section defined between the adjacent mount portions to a center portion of the spacing distance section.

According to the exemplary embodiment of the present disclosure, the edge groove may be continuously provided between the adjacent mount portions along the edge portion of the plate body.

According to the exemplary embodiment of the present disclosure, the edge groove may be provided so as not to overlap the mount portion.

According to the exemplary embodiment of the present disclosure, the door module plate for a vehicle may include a sealing member accommodated in the edge groove.

According to the exemplary embodiment of the present disclosure, the reinforcement rib may press the sealing member between the plate body and an in-panel stacked on the plate body to cover the edge groove.

According to the exemplary embodiment of the present disclosure, the plate body may be made of recycled plastic.

According to the exemplary embodiment of the present disclosure, the plate body may include fiberglass of 35 wt % or less.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for explaining a door module plate for a vehicle according to an exemplary embodiment of the present disclosure.

FIG. 2 is a top plan view for explaining the door module plate for a vehicle according to the exemplary embodiment of the present disclosure.

FIG. 3 is a view for explaining a reinforcement rib of the door module plate for a vehicle according to the exemplary embodiment of the present disclosure.

FIG. 4 is a cross-sectional view taken along line A-A in FIG. 2.

FIG. 5 is a view for explaining a sealing member of the door module plate for a vehicle according to the exemplary embodiment of the present disclosure.

FIG. 6 is a view for explaining a height of the reinforcement rib of the door module plate for a vehicle according to the exemplary embodiment of the present disclosure.

FIG. 7 is a flowchart for explaining a method of manufacturing the door module plate for a vehicle according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and in described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments described herein but may be implemented in various different forms. at least one of the constituent elements in the exemplary embodiments of the present disclosure may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

Furthermore, the terms used in the exemplary embodiments of the present disclosure are for explaining the embodiments, not for limiting the present disclosure.

In the present specification, unless stated otherwise, a singular form may also include a plural form. The expression “at least one (or one or more) of A, B, and C” may include one or more of all combinations that may be made by combining A, B, and C.

Furthermore, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is described as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

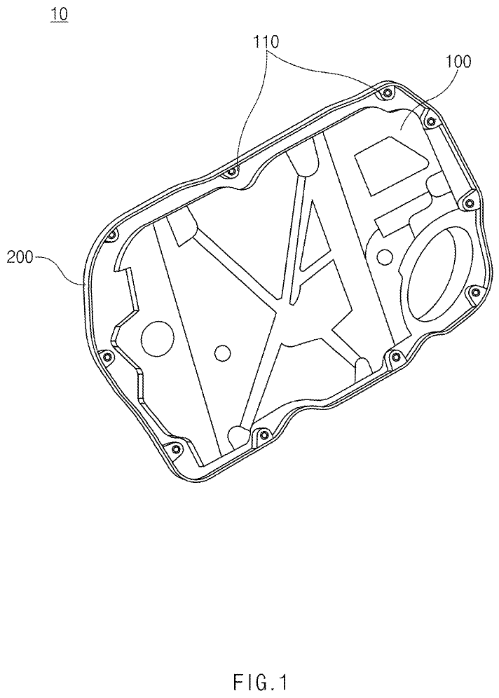

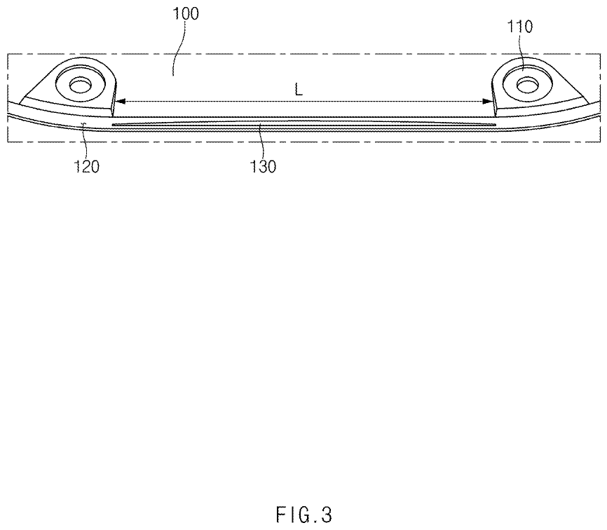

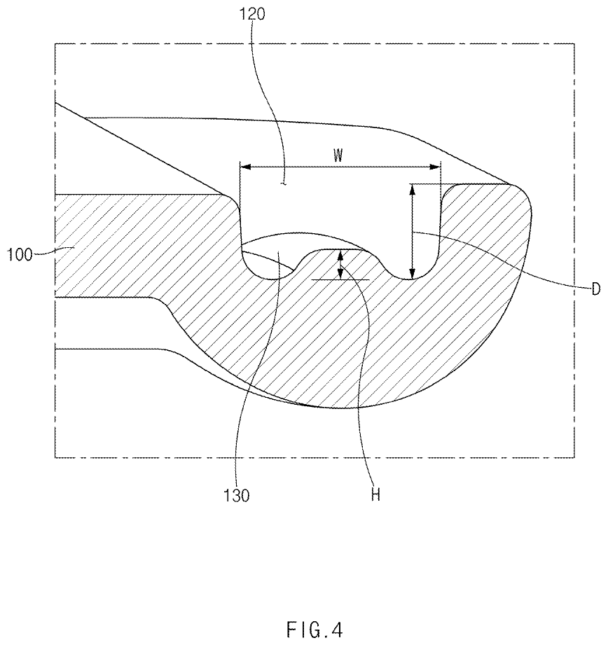

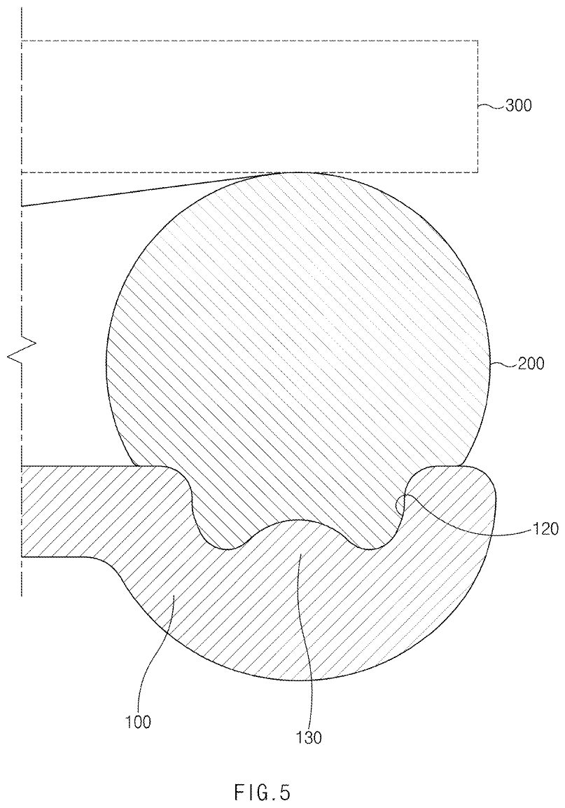

With reference to FIGS. 1 to 7, a door module plate 10 for a vehicle includes a plate body 100 provided to correspond to a door of a vehicle, mount portions 110 provided at an edge portion of the plate body 100 and fastened to fastening members, an edge groove 120 provided at the edge portion of the plate body 100, and a reinforcement rib 130 integrally protruding from an internal surface of the edge groove 120.

This is to ensure structural rigidity of the door module plate 10 for a vehicle and improve safety and reliability of the door module plate 10.

That is, a main material of the door module plate may be changed to recycled plastic which is an environmental-friendly material. However, because recycled plastics are processed by applying heat thereto, it is difficult to ensure sufficient physical properties (e.g., mechanical strength). For the present reason, it is difficult to ensure sufficient mechanical strength of the door module plate.

In contrast, according to the exemplary embodiment of the present disclosure, the reinforcement rib 130 is integrally provided on the internal surface of the groove 120. Therefore, it is possible to obtain an advantageous effect of ensuring the structural rigidity of the door module plate 10 and improving the safety and reliability of the door module plate 10.

According to the exemplary embodiment of the present disclosure, it is possible to ensure sufficient mechanical strength of an edge portion of the door module plate 10, on which a sealing member 200 is accommodated, even when the main material of the door module plate 10 is changed to recycled plastic which is an environmental-friendly material. Therefore, it is possible to obtain an advantageous effect of reducing the manufacturing costs and improving the efficiency of the door module plate 10.

The plate body 100 is provided to correspond to the door of the vehicle. The plate body 100, together with an in-panel 300 for a vehicle door (e.g., an in-panel made of a metallic material), forms the door module plate 10 for a vehicle.

For example, the plate body 100 may be provided to include an approximately quadrangular plate shape corresponding to the door of the vehicle.

The plate body 100 may include a plurality of mounting grooves 140 in which accessory components for a vehicle door are mounted.

The number of mounting grooves 140, the positions of the mounting grooves 140, the types of accessory components mounted in the mounting grooves 140 may be variously changed in accordance with required conditions and design specifications. The present disclosure is not restricted or limited by the number of mounting grooves 140, the positions of the mounting grooves 140, the types of accessory components mounted in the mounting grooves 140.

For example, various types of accessory components, such as a motor, a speaker, and a window regulator for moving a window glass upward or downward, may be mounted in the mounting grooves 140.

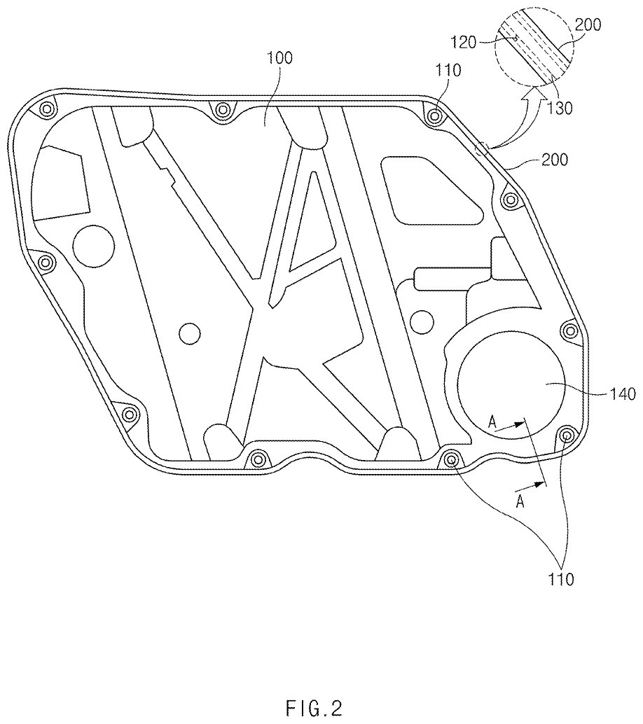

With reference to FIGS. 2 to 6, the mount portions 110 are provided at the edge portion of the plate body 100 so that the fastening members for fastening the plate body 100 and the in-panel 300 are fastened to the mount portions 110.

The mount portion 110 defines a space in which the fastening member for fastening the plate body 100 to the in-panel 300 is disposed. For example, the mount portion 110 may protrude from a front surface of the plate body 100 and include a fastening hole (or fastening groove) to which a fastening bolt is fastened.

The mount portion 110 may be provided as a plurality of mount portions 110 spaced from one another along an external edge portion of the plate body 100 to increase a coupling force (fastening force) between the plate body 100 and the in-panel 300.

The number of mount portions 110 and the spacing interval between the mount portions 110 may be variously changed in accordance with required conditions and design specifications. The present disclosure is not restricted or limited by the number of mount portions 110 and the spacing interval between the mount portions 110.

According to the exemplary embodiment of the present disclosure, the mount portions 110 may be spaced from one another at predetermined intervals along the external edge portion of the plate body 100. According to another exemplary embodiment of the present disclosure, the plurality of mount portions may be spaced from one another at irregular intervals along the external edge portion of the plate body.

For reference, when the number of mount portions 110 increases, the sealability between the plate body 100 and the in-panel 300 may be improved. However, in case that the number of mount portions 110 excessively increases, the manufacturing efficiency inevitably deteriorates, and the manufacturing time increases. Therefore, the number of mount portions 110 and the spacing interval between the mount portions 110 may be set in consideration of the sealability and manufacturing efficiency. For example, the mount portions 110 may be provided on the center portion and the edge portion of the plate body 100 to be spaced from one another.

According to the exemplary embodiment of the present disclosure, a spacing distance L between the adjacent mount portions 110 may be defined to be 100 to 250 mm.

That is, when the spacing distance L between the adjacent mount portions 110 is shorter than 100 mm or longer than 250 mm, a coupling force (fastening force) applied by the fastening member gradually decreases toward a center portion between the adjacent mount portions 110. For the present reason, the in-panel 300 and the plate body 100 may be separated from each other. In case that the plate body 100 and the in-panel 300 are separated from each other at the center portion between the adjacent mount portions 110, a water leakage may occur, which may cause a defect of the door module plate for a vehicle. Therefore, the spacing distance L between the adjacent mount portions 110 may be defined as 100 to 250 mm.

TABLE 1

| Spacing distance (mm) between | Separation |
|---|---|
| mount portions 110 | (mm) |
| 135.77 | 2 |
| 140.31 | 2 |
| 188.13 | 2.5 |
| 192.71 | 3 |
| 202.57 | 3 |
| 203.3 | 3 |
| 217.31 | 3 |
| 225.25 | 3 |
| 226.92 | 3.5 |
| 239.11 | 3.5 |

For reference, Table 1 shows separation intervals of the in-panel 300 with respect to spacing distances between the adjacent mount portions 110 in the plate body 100 according to the exemplary embodiment of the present disclosure. For example, the plate body 100 may include a width of 801.9 mm and a height of 533.57 mm. A total of ten mount portions 110 may be provided along an external peripheral rim. With reference to Table 1, it may be seen that the separation interval tends to increase as the distance between the mount portions 110 increases.

In the exemplary embodiment of the present disclosure illustrated and described above, the example has been described in which the spacing distance between the adjacent mount portions 110 is defined as 100 to 250 mm. However, the spacing distance between the adjacent mount portions 110 may vary depending on an overall size of the plate body 100. The present disclosure is not restricted or limited by the spacing distance.

The edge groove 120 is provided at the edge portion (e.g., outermost periphery edge portion) of the plate body 100 to define a space into which the sealing member 200 (e.g., sealing foam) is inserted and fixed.

According to the exemplary embodiment of the present disclosure, the edge groove 120 may be provided between the adjacent mount portions 110 (a spacing distance section defined between the adjacent mount parts).

The edge groove 120 may be continuously provided between the adjacent mount portions 110 to include an approximately continuous band shape along the edge portion of the plate body 100. According to another exemplary embodiment of the present disclosure, a plurality of edge grooves may be provided between the adjacent mount portions and spaced from one another.

According to the exemplary embodiment of the present disclosure, the door module plate 10 for a vehicle may include the sealing member 200 accommodated (mounted) in the edge groove 120.

The sealing member 200 is provided to seal a gap between the plate body 100 and the in-panel 300. The present disclosure is not restricted or limited by the material and properties of the sealing member 200.

For example, typical sealing foam may be used as the sealing member 200.

According to the exemplary embodiment of the present disclosure, a depth D of the edge groove 120 may be defined as 2.0 mm or less, and a width W of the edge groove 120 may be defined as 6.0 mm or less.

That is, the depth D and the width W of the edge groove 120 may increase in proportion to a size of the plate body 100 and a diameter of the sealing member 200. However, when the depth D and the width W of the edge groove 120 exceed the ranges (when the depth of the edge groove is more than 2.0 mm and the width W of the edge groove is more than 6.0 mm), the mechanical strength of the edge portion of the plate body 100 may decrease, and the effect of improving sealability by increasing the diameter of the sealing member 200 is not high. Therefore, the depth D of the edge groove 120 may be defined as 2.0 mm or less, and the width W of the edge groove 120 may be defined as 6.0 mm or less.

For reference, the size of the sealing member 200 is slightly greater than the size of the edge groove 120. When the sealing member 200 is fixedly inserted into the edge groove 120, the elasticity of the sealing member 200 may press the in-panel 300 and the plate body 100 and seal the portion between the in-panel 300 and the plate body 100, providing the sealability to the door module plate 10 for a vehicle and effectively preventing a water leakage.

The reinforcement rib 130 integrally protrudes from the internal surface of the edge groove 120.

The reinforcement rib 130 integrally protrudes from a bottom surface of the edge groove 120 that faces the in-panel 300.

As described above, in the exemplary embodiment of the present disclosure, the reinforcement rib 130 is provided on the internal surface of the edge groove 120. Therefore, it is possible to reinforce (increase) the mechanical strength of the edge portion of the plate body 100 and improve the sealing performance of the sealing member 200 by pressing (additionally compressing) the sealing member 200 between the in-panel 300 and the plate body 100.

That is, the reinforcement rib 130, which protrudes from the internal surface of the edge groove 120, may press the sealing member 200, reducing the separation interval between the mount portion 110 and the plate body 100. It is possible to effectively eliminate the separation interval by increasing a pressing force on the sealing member 200 at the center portion between the adjacent mount portions 110.

The reinforcement rib 130 may have various structures and shapes in accordance with required conditions and design specifications. The present disclosure is not restricted or limited by the structure and shape of the reinforcement rib 130.

According to the exemplary embodiment of the present disclosure, the reinforcement rib 130 may be integrated with the plate body 100 and include an external peripheral surface having a curvature.

In an exemplary embodiment of the present invention, a height H of the reinforcement rib 130 is lower than a height of the plate body 100.

In an exemplary embodiment of the present invention, a height of the reinforcement rib 130 is lower than a height D of edge groove 120.

According to the exemplary embodiment of the present disclosure, the reinforcement rib 130 may be integrated with the plate body 100 together with the edge groove 120 at the time of forming the plate body 100 (e.g., by extrusion).

As described above, in the exemplary embodiment of the present disclosure, the plate body 100 and the reinforcement rib 130 are formed together by a single process (extrusion). Therefore, a separate process of forming the reinforcement rib 130 may be eliminated. Therefore, it is possible to obtain an advantageous effect of simplifying the manufacturing process and improving the manufacturing efficiency.

Moreover, according to the exemplary embodiment of the present disclosure, the reinforcement rib 130 may be provided on the internal surface of the edge groove 120, reinforcing (improving) the mechanical strength of the edge portion of the plate body 100.

According to the exemplary embodiment of the present disclosure, the reinforcement rib 130 may satisfy Expressions 1 and 2 below.

$$0.26 D < H < 0.85 D \qquad [ Expression 1 ]$$

$$H ∝ L \qquad [ Expression 2 ]$$

Here, H represents a height of the reinforcement rib 130, D represents a depth of the groove 120, and L represents a spacing distance between the adjacent mount portions 110.

According to the exemplary embodiment of the present disclosure, a height H of the reinforcement rib 130 may be defined as 0.5 to 1.5 mm.

The height H of the reinforcement rib 130 is determined within the range (0.5 to 1.5 mm), and the height may vary within the depth of the edge groove 120 based on Expression 1.

For reference, the height H of the reinforcement rib 130 may be derived from the experiment that changes the height depending on the depth D of the edge groove 120.

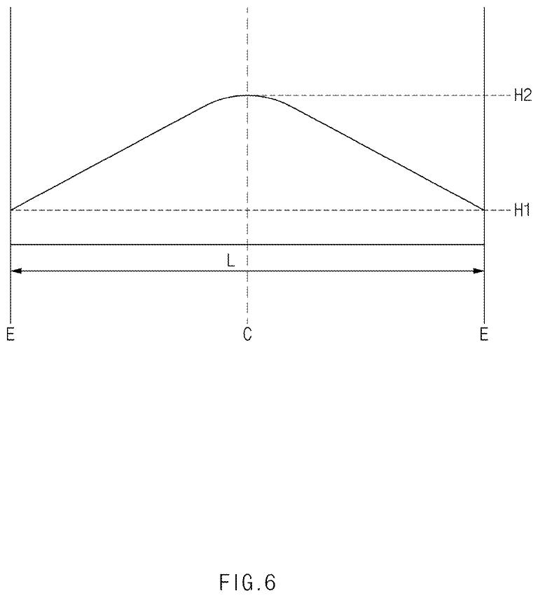

According to the exemplary embodiment of the present disclosure, the height H of the reinforcement rib 130 may be defined to gradually increase (H2>H1) in a direction from one end portion (see E in FIG. 6) of the spacing distance section defined between the adjacent mount portions 110 to the center portion (see C in FIG. 6) of the spacing distance section.

Furthermore, according to the exemplary embodiment of the present disclosure, the width W of the reinforcement rib 130 may be defined to gradually increase in the direction from one end portion (see E in FIG. 6) of the spacing distance section defined between the adjacent mount portions 110 to the center portion (see C in FIG. 6) of the spacing distance section.

Based on Expression 2, the height H of the reinforcement rib 130 may increase as the distance between the mount portions 110 increases. The height H of the reinforcement rib 130 may increase to a range of about 85% of a maximum depth of the edge groove 120.

In the exemplary embodiment of the present disclosure, the reinforcement rib 130 may press the sealing member 200 (press the sealing member between the in-panel and the plate body), sealing the portion between the plate body 100 and the in-panel 300.

This is based on the fact that when the spacing distance between the adjacent mount portions 110 increases, the separation between the plate body 100 and the in-panel 300 may increase at the time of fastening the plate body 100 and the in-panel 300. The separation may occur at the center portion between the adjacent mount portions 110 as the fastening force applied by the mount portion 110 decreases.

However, according to the exemplary embodiment of the present disclosure, the height and width of the reinforcement rib 130 gradually increase in the direction from one end portion of the spacing distance section defined between the adjacent mount portions 110 to the center portion of the spacing distance section so that the reinforcement rib 130 defines the highest height and the maximum width at the center portion between the adjacent mount portions 110. Therefore, the sealing member 200 may be maximally pressed at the portion where the separation increases, effectively preventing a water leakage caused by the separation between the plate body 100 and the in-panel 300.

According to the exemplary embodiment of the present disclosure, the reinforcement rib 130 is formed to include an external surface (peripheral surface) having a curvature. Because the external surface of the reinforcement rib 130 includes a curvature as described above, it is possible to obtain an advantageous effect of preventing damage to the sealing member 200 at the time of pressing the sealing member 200 and more effectively suppressing the likelihood of water leakage.

For example, the external surface of the reinforcement rib 130 may be provided in an approximately semicircular shape having a radius of curvature of 0.5 to 10 R. Alternatively, the reinforcement rib 130 may be provided in a trapezoidal shape including a curved edge portion or provided in other shapes.

As described above, the reinforcement rib 130 may be provided inside the edge groove 120 and increase the mechanical strength of the plate body 100.

According to the exemplary embodiment of the present disclosure, the plate body 100 may be made of recycled plastic (recycled plastic is used as a main material).

However, when the plate body 100 includes recycled plastic, the mechanical strength of the plate body 100 may decrease. Because the fastening members are fastened to the mount portions 110 provided at the edge portion of the plate body 100, the edge portion of the plate body 100 may be easily damaged by the concentration of stress applied at the time of fastening the fastening members.

In contrast, according to the exemplary embodiment of the present disclosure, the reinforcement rib 130 is provided on the internal surface of the edge groove 120 provided at the edge portion of the plate body 100 so that the mechanical strength of the edge portion of the plate body 100 may be increased. Therefore, it is possible to obtain an advantageous effect of minimizing the deformation of and damage to the edge portion of the plate body 100 caused by the concentration of stress applied at the time of fastening the fastening member.

The reinforcement rib 130 may be provided continuously on the internal surface of the edge groove 120 in a longitudinal direction of the edge groove 120.

According to the exemplary embodiment of the present disclosure, the height H and the width W of the reinforcement rib 130 increase toward the center portion between the mount portions 110. Therefore, it is possible to obtain an advantageous effect of more effectively improving the mechanical strength of the portion where the mechanical strength decreases greatly (the center portion between the mount portions that has low mechanical strength).

According to the exemplary embodiment of the present disclosure, the edge groove 120 may be provided so as not to overlap the mount portion 110.

In other words, the reinforcement rib 130 may not be provided on the mount portion 110.

As described above, according to the exemplary embodiment of the present disclosure, the reinforcement rib 130 is not provided on the mount portion 110. Therefore, it is possible to concentratedly reinforce the mechanical strength of the portion of the plate body 100 that has relatively low mechanical strength (the portion between the adjacent mount portions 110).

According to the exemplary embodiment of the present disclosure, the plate body 100 may include fiberglass of 35 wt % or less.

In general, short-glass-fiber-reinforced composite polypropylene (PP-SGF) or long-glass-fiber-reinforced composite polypropylene (PP-LGF) is mainly used as a reinforcing material for increasing mechanical strength of the module plate for a vehicle. In the exemplary embodiment of the present disclosure, long-glass-fiber-reinforced composite polypropylene (PP-LGF) containing fiberglass of 70 wt % or less is selected and used as a reinforcing material for the plate body 100. Therefore, it is possible to ensure sufficient mechanical strength of the plate body 100 even when the plate body 100 is formed by use of recycled plastic as a main material.

According to the exemplary embodiment of the present disclosure, the plate body 100 may be stacked on the in-panel 300 made of metal, forming the door module plate 10 for a vehicle.

Among other things, according to the exemplary embodiment of the present disclosure, the structural change is implemented so that the edge groove 120 is provided at the edge portion of the plate body 100 and the reinforcement rib 130 is provided inside the edge groove 120 so that the sealing performance of the sealing member 200 may be improved. Furthermore, the reinforcement rib 130 is formed to include the maximum height and the maximum width at the portion where the mechanical strength of the plate body 100 decreases (the center portion between the adjacent mount portions 110) so that the mechanical strength of the plate body 100 may be increased. Therefore, it is possible to manufacture the door module plate 10 for a vehicle that maintains safety and reliability even when recycled plastic is used as a main material.

The door module plate 10 for a vehicle according to the exemplary embodiment of the present disclosure includes the plate body 100 made of recycled plastic. However, the door module plate 10 may include the same mechanical strength as a door module plate including a plate body made of non-recycled plastic (polypropylene (PP)).

Hereinafter, a method of manufacturing the door module plate for a vehicle according to the exemplary embodiment of the present disclosure will be described.

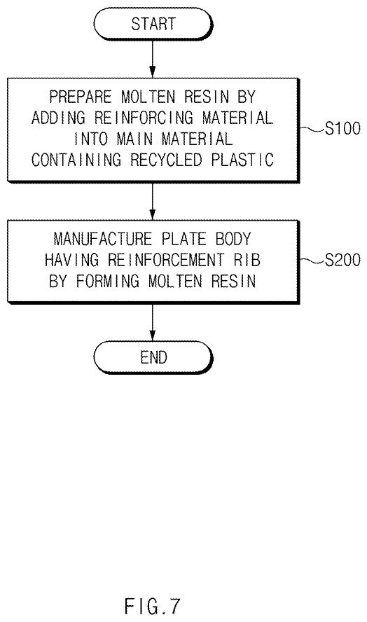

FIG. 7 is a flowchart for explaining the method of manufacturing the door module plate for a vehicle according to the exemplary embodiment of the present disclosure.

With reference to FIG. 7, the method of manufacturing the door module plate for a vehicle according to the exemplary embodiment of the present disclosure includes (a) preparing molten resin by adding a reinforcing material into a main material containing recycled plastic, and (b) manufacturing the plate body 100 including the reinforcement rib 130 by forming molten resin.

First, molten resin is provided by adding a reinforcing material into a main material containing recycled plastic (S100).

TABLE 2

| | Manu- | Manu- | Manu- | Manu- | Manu- | Manu- |
|---|---|---|---|---|---|---|
| | fac- | fac- | fac- | fac- | fac- | fac- |
| | turing | turing | turing | turing | turing | turing |
| | Ex- | Ex- | Ex- | Ex- | Ex- | Ex- |
| | ample | ample | ample | ample | ample | ample |
| Components | 1 | 2 | 3 | 4 | 5 | 6 |
| Recycled | — | 10 | 20 | 30 | 40 | 50 |
| PP | | | | | | |
| (wt %) | | | | | | |
| Tensile | 93 | 85 | 82 | 77 | 75 | 73 |
| strength | | | | | | |
| (MPa) | | | | | | |
| Extension | 2.6 | 2.3 | 2.2 | 2.2 | 2.1 | 2.1 |
| ratio (%) | | | | | | |

Table 2 shows variation values of tensile strength and extension ratios of the plate body 100 formed by adding recycled plastic (recycled PP) into the main material (polypropylene (PP)). With reference to Table 2, it may be seen that in Manufacturing Examples 2 to 6, the tensile strength and the extension ratio decrease as the amount of added recycled PP increases so that there is a problem with the rigidity of the plate body 100 in comparison with Manufacturing Example 1 in which no recycled plastic is contained. Therefore, the reinforcing material may be added to solve the problem.

According to the exemplary embodiment of the present disclosure, the molten resin may be provided by adding fiberglass of 20 wt %, as a reinforcing material, into the main material of 80 wt % containing recycled plastic (recycled PP) of 10 wt % and polypropylene of 70 wt %. The molten resin may be provided by adding long-glass-fiber-reinforced composite polypropylene (e.g., PP-LGF60 (GF 60 wt %, PP 40 wt %)) of 33 wt % containing fiberglass of 70 wt % or less, as a reinforcing agent, into the main material of 67 wt % containing recycled plastic (recycled PP) of 10 wt % and polypropylene of 57 wt %.

Next, the plate body 100 including the reinforcement rib 130 is manufactured by forming the molten resin (S200).

In step S200 of manufacturing the plate body 100, the edge groove 120 and the reinforcement rib 130 may be integrated in the plate body 100.

For reference, the external peripheral surface of the reinforcement rib 130 may include a curvature, and the height H may be determined based on Expressions 1 and 2 below.

$$0.26 D < H < 0.85 D \qquad [ Expression 1 ]$$

$$H ∝ L \qquad [ Expression 2 ]$$

In Expressions 1 and 2, H represents a height of the reinforcement rib 130, D represents a depth of the groove 120, and L represents a spacing distance between the adjacent mount portions 110.

According to the exemplary embodiment of the present disclosure, the method of manufacturing the door module plate for a vehicle may further include attaching the sealing member 200 fixedly inserted into the edge groove 120 after the manufacturing of the plate body 100.

For reference, the reinforcement rib 130 is integrated with the plate body 100 so that the external peripheral surface thereof includes a curvature so that the reinforcement rib 130 may effectively press the sealing member 200 without damaging the sealing member 200.

Furthermore, according to the exemplary embodiment of the present disclosure, the height of the reinforcement rib 130 according to the depth of the edge groove 120 is determined based on Expressions 1 and 2 so that the mechanical strength of the plate body 100 may be reinforced. Furthermore, the reinforcement rib 130 of the plate body 100 coupled to the in-panel 300 may press the sealing member 200 to prevent the separation between the plate body 100 and the in-panel 300, more effectively preventing (suppressing) a water leakage from the door plate module.

According to an exemplary embodiment of the present disclosure described above, it is possible to obtain an advantageous effect of ensuring the structural rigidity of the door module plate and improving the safety and reliability of the door module plate.

According to an exemplary embodiment of the present disclosure, it is possible to obtain an advantageous effect of improving the mechanical strength of the edge portion of the door module plate on which the sealing member is accommodated.

Furthermore, according to an exemplary embodiment of the present disclosure, it is possible to obtain an advantageous effect of improving the sealing performance.

Furthermore, according to an exemplary embodiment of the present disclosure, it is possible to obtain an advantageous effect of reducing the costs and improving the marketability.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A door module plate for a vehicle, the door module plate comprising:
a plate body provided to correspond to a door of a vehicle;
a mount portion provided at an edge portion of the plate body and configured to be fastened to a fastening member;
an edge groove provided at the edge portion of the plate body; and
a reinforcement rib integrally protruding from an internal surface of the edge groove.

2. The door module plate of claim 1, wherein a height of the reinforcement rib is lower than a height of the plate body.

3. The door module plate of claim 1, wherein a height of the reinforcement rib is lower than a height of edge groove.

4. The door module plate of claim 3, wherein the reinforcement rib satisfies Expression 1 below, and
$$0.26 D < H < 0.85 D \qquad [ Expression 1 ]$$
wherein H represents the height of the reinforcement rib, D represents a depth of the edge groove.

5. The door module plate of claim 4, wherein the depth of the edge groove is defined as 2 mm or less than 2 mm.

6. The door module plate of claim 1, wherein the mount portion is provided as a plurality of mount portions spaced from one another along the edge portion of the plate body, and the edge groove is provided between adjacent mount portions.

7. The door module plate of claim 6, wherein the reinforcement rib satisfies Expressions 1 and 2 below, and
$$0.26 D < H < 0.85 D \qquad [ Expression 1 ]$$
$$H ∝ L \qquad [ Expression 2 ]$$
wherein H represents a height of the reinforcement rib, D represents a depth of the edge groove, and L represents a spacing distance between the adjacent mount portions.

8. The door module plate of claim 7, wherein the depth of the edge groove is defined as 2 mm or less than 2 mm, and a width of the edge groove is defined as 6 mm or less than 6 mm.

9. The door module plate of claim 7, wherein the height of the reinforcement rib is defined as 0.5 to 1.5 mm.

10. The door module plate of claim 7, wherein the spacing distance is defined as 100 to 250 mm.

11. The door module plate of claim 7, wherein the height of the reinforcement rib increases in a direction from one end portion of a spacing distance section defined between the adjacent mount portions to a center portion of the spacing distance section.

12. The door module plate of claim 4, wherein the edge groove is continuously provided between the adjacent mount portions along the edge portion of the plate body.

13. The door module plate of claim 1, wherein the edge groove is provided so as not to overlap the mount portion.

14. The door module plate of claim 1, including:
a sealing member accommodated in the edge groove.

15. The door module plate of claim 14, wherein the reinforcement rib presses the sealing member between the plate body and an in-panel stacked on the plate body to cover the edge groove.

16. The door module plate of claim 1, wherein the plate body includes recycled plastic.

17. The door module plate of claim 1, wherein the plate body includes fiberglass of 35 wt % or less than 35 wt %.
